(19) United States
(12) Patent Application Publication
(10) Pub. No.: US 2023/0112996 A1
(43) Pub. Date: Apr. 13, 2023

(54) COMPILATION FOR FUNCTION AS A SERVICE IMPLEMENTATIONS DISTRIBUTED ACROSS SERVER ARRAYS

(71) Applicant: Intel Corporation, Santa Clara, CA (US)

(72) Inventors: BIN YANG, Shanghai (CN); Jia Bao, Shanghai (CN); Mohammad Haghighat, San Jose, CA (US); Fei Li, Shanghai (CN); Zhiwei Li, Shanghai (CN); Mingqui Sun, Bevearton, OR (US); Tao Xu, Shanghai (CN); Zhen Zhou, Shanghai (CN)

(21) Appl. No.: 17/907,261

(22) PCT Filed: Apr. 30, 2020
(86) PCT No.: PCT/CN2020/088268

§ 371 Date: Sep. 24, 2022

(51) Int. Cl. G06F 8/41; G06F 8/77

(52) U.S. Cl. CPC G06F 8/447; G06F 8/77

(57) ABSTRACT

Systems, apparatuses and methods may be associated with a first computing device and provide for identifying performance metrics. The performance metrics are associated with execution of a first function on at least one second computing device. The systems, apparatuses and methods aggregate the performance metrics to generate aggregated performance metrics, determine that the aggregated performance metrics meet a threshold and compile code associated with the first function in response to the aggregated performance metrics being determined to meet the threshold.

### TECHNICAL FIELD

Embodiments generally relate to software deployment. More particularly, embodiments relate to enhanced compilation operations in distributed computing systems.

### BACKGROUND

Function as a Service (FaaS) is a computing model that may provide a platform allowing customers to develop, run, and manage application functionalities without the complexity of building and maintaining infrastructure typically associated with developing and launching an application. Building an application following a FaaS model may achieve a “serverless” architecture. Software developers may leverage FaaS to deploy an individual “function,” action, or piece of logic. FaaS functions may be ephemeral and short-lived.

### BRIEF DESCRIPTION OF THE DRAWINGS

The various advantages of the embodiments will become apparent to one skilled in the art by reading the following specification and appended claims, and by referencing the following drawings, in which:

FIG. 1 is a process flow diagram of an example of a function deployment, analysis and compilation process according to an embodiment;

FIG. 2 is a flowchart of an example of a method of enhanced code compilation associated with a first computing device and based on performance metrics from a server array according to an embodiment;

FIG. 3 is a block diagram of an example of a computing architecture according to an embodiment;

FIG. 4 is a process flow diagram of an example of tracking and uploading profiling data according to an embodiment;

FIG. 5 is a flowchart of an example of a method of implementing a function code service according to an embodiment;

FIG. 6 is a flowchart of an example of a method of uploading profiling data and compiling a function according to an embodiment;

FIG. 7 is a flowchart of an example of a method of generating compiled codes for one or more computing architectures according to an embodiment;

FIG. 8 is a flowchart of an example of a method of de-compiling compiled codes according to an embodiment;

FIG. 9 is a flowchart of an example of a method of normalizing counters according to an embodiment;

FIG. 10 is a block diagram of an example of a performance-enhanced computing system according to an embodiment;

FIG. 11 is an illustration of an example of a semiconductor apparatus according to an embodiment;

FIG. 12 is a block diagram of an example of a processor according to an embodiment; and

FIG. 13 is a block diagram of an example of a multi-processor based computing system according to an embodiment.

### DESCRIPTION OF EMBODIMENTS

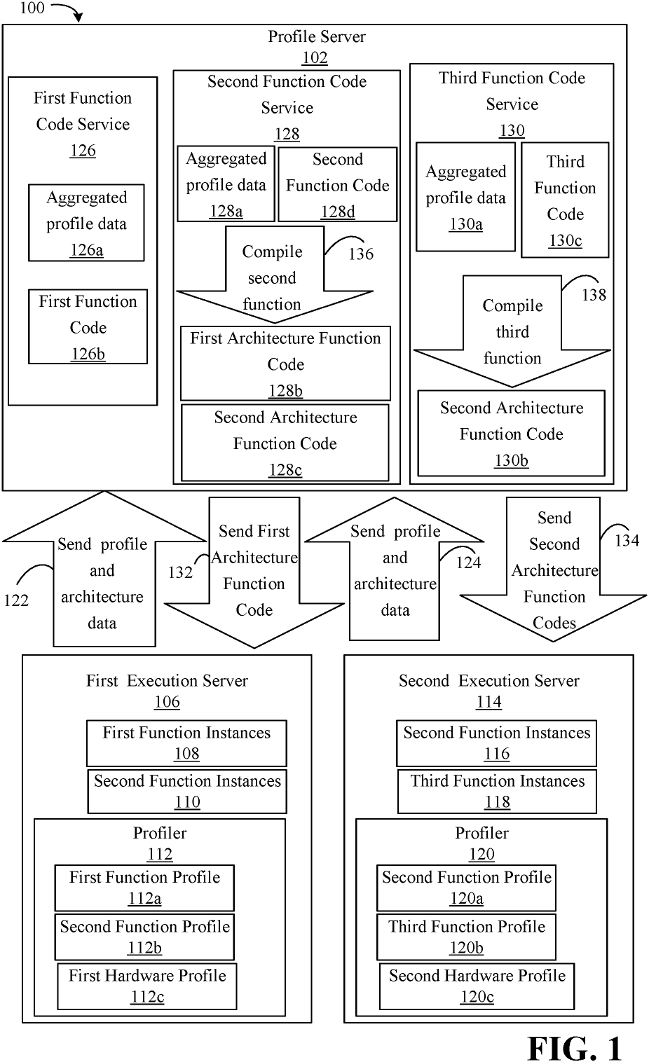

Turning now to FIG. 1, a function deployment, analysis and compilation process 100 is illustrated. In process 100, a dynamic ensemble compilation (e.g., a just-in-time (JIT) compilation) may be implemented to compile a FaaS workload. Each invocation of a FaaS function may be short-lived and potentially unrelated to other invocations functions. Process 100 may analyze the short-lived FaaS functions by aggregating different profiling data from different FaaS runtime instances across a cloud-based system to identify “hotspots” and compile the “hotspots” accordingly.

In contrast, conventional designs (e.g., compilers, data sharing processes, profilers, etc.) may be unable to fully appreciate the full scope of each function due to the ephemeral nature of the function. For example, the function may execute numerous times across a wide array of servers (e.g., computing devices). That is, in a FaaS scenario, each isolated runtime may execute for just single invocation or limited number of services. The short lifetime prevents a meaningful generation of a valid profile to guide optimization. Thus, some conventional designs may be unable to identify functions that include “hot spots” (e.g., region of a computer program where a high proportion of executed instructions occur). As such, conventional designs may be unable to identify FaaS functions that would benefit the most from compilation and more extensive analysis for enhancements, and thus is unable to efficiently compile FaaS functions.

Process 100 may enhance execution by identifying functions that include hotspots, selectively compiling the functions that include hotspots and sharing the compiled code across a plurality of servers. Cold functions may not be compiled to avoid the associated overhead. In doing so, performance may be enhanced since the hot functions may have compiled code that operates more efficiently than other implementations (e.g., interpreted code) of the same function. Cold functions may not need to be compiled and/or as aggressively analyzed for optimization.

That is, compiling code may incur more overhead (e.g., increased latency and computing resources) relative to interpreting code. Such overhead may be acceptable as long as the function executes a certain number of times since each function execution will execute more efficiently (e.g., reduced latency and computing resources). Thus, over the number of iterations, the enhanced and efficient execution of the function will outweigh the increased overhead from compilation (e.g., the cost of compilation is less than the reduction in cost of executing the function for several invocations). If a function is cold (e.g., does not execute frequently) then the function may not be compiled as the overhead may never be justified (e.g., the cost of compilation is more than the reduction in cost of executing the function for several invocations). Thus, process 100 may reduce an amount of resources that are utilized since functions are selectively compiled based on whether the functions are hot or cold and based on a threshold that may be set based on the above. Thus, even though two functions may form part of a same program, only one of the functions may be compiled while the other function may not be compiled.

It will be understood that varying levels of compilation may further be applied based on a measure of how many times a function has executed over a time period. That is, higher overhead compilation (may aggressively analyze and optimize code) may be applied to functions that occur frequently, while a lower overhead compilation (may not optimize and analyze code to the extent that the higher overhead compilation optimizes code) may be applied to functions that occur less frequently. Thus, some embodiments may re-compile code of a function (e.g., a function that was previously compiled) in response to the function executing a certain number of times to analyze the function for further efficiency enhancements.

In FIG. 1, ensemble compilation process 100 profiles and collects an information fragment from each FaaS workload and aggregates the information fragments to determine a meaningful compilation decision. Ensemble compilation may compile a target method into native code required for a specific architecture (e.g., for a µarch or uarch, acceleration architectures and/or the way a given instruction set architecture (ISA) is implemented in a particular processor) to simultaneously support heterogeneous hardware. A class preload mechanism may be designed to reduce query interaction between an Ensemble JIT service and real workload to execute a JIT operation. The ensemble compilation may be designed to quickly and efficiently adapt to data set changes and hotspot changes. For example, not only are hotspots identified and compiled, but cold functions may be decompiled. Thus, the ensemble compilation may be efficient and adaptive.

FIG. 1 illustrates a distributed architecture that includes a profile server 102 connected with first and second execution servers 106, 114. The profile server 102, the first execution server 106 and the second execution server 114 may be part of a same cloud computing environment and connected to each other through a suitable medium (e.g., wired and/or wireless connections). Furthermore, the profile server 102, the first execution server 106 and the second execution server 114 may each be a computing device.

The first and second execution servers 106, 114 may be executing first, second functions and third functions (e.g., instances). For example, the first execution server 106 may be executing first function instances 108 (each corresponding to an implementation of the first function) and second function instances 110 (each corresponding to an implementation of the second function), while the second execution server 114 may be executing second function instances 116 (each corresponding to an implementation of the second function) and third function instances 118 (each corresponding to an implementation of the third function).

The first and second execution servers 106, 114 may track performance metrics (e.g., invocations of functions) during execution of the first function instances 108, the second function instances 110, the second function instances 116 and the third function instances 118. The profile server 102 may determine whether to compile the first, second and third functions based on the number of invocations of the first, second and third functions.

For example, the first and second execution servers 106, 114 may include profilers 112, 120 to profile the execution of the first function instances 108, the second function instances 110, the second function instances 116 and the third function instances 118 as well as architectures (e.g., hardware features, instruction set architectures of processors, memory size, cache size, clock speed, processor speed, processor type, etc.) of the first and second execution servers 106, 114.

The profilers 112, 120 may each profile local service and function service on the respective first and second execution servers 106, 114 to generate performance metrics. In detail, the profiler 112 may be responsible for collecting profiling data (e.g., performance metrics) from function service runtimes of the first and second function instances 108, 110. The profiler 112 may further query architecture information of the underlying hardware of the first execution server 106, and store the architecture information in association with an identifier (e.g., IP address) of the first execution server 106. The profiler 112 may store the performance metrics of the first function instances 108 as the first function profile 112a. The profiler 112 may store performance metrics of the second function instances 110 as the second function profile 112b. The profiler 112 may store hardware specific data (e.g., architecture) of the first execution server 106 as the first hardware profile 112c.

Thus, the profiler 112 may measure characteristics of the execution of the first and second functions on the first execution server 106 to generate the performance metrics. For example, the profiler 112 may have counters for a same service function. The values of the counters may each be a different performance metric. For example, the counters may include a method invocation counter, loop backedge counter, branch taken and not taken counters, etc. Thus, the performance metrics may generally indicate how many times a function is invoked, and how many times various portion of the function are invoked.

Moreover, the counters may be normalized. For example, in order for aggregation to execute on different physical platforms with architectural differences (e.g., CPU core number differences, core clock differences, power differences, memory differences, etc.), normalized counters may be implemented and reported to the profile server 102. That is, normalized values of the counters may be stored as the performance metrics of the first function profile 112a and the second function profile 112b. The normalized counter may be equal to the reported counter divided by the reported duration over which the counter has been counting. Equation one may be one implementation of a normalized counter:

$$\text{Normalized counter} \text{=} \text{reported counter/reported duration} \text{.}$$

Similarly, the second execution server 114 may include a profiler 120 that executes similarly to the profiler 112. The profiler 120 may be responsible for collecting profiling data from function service runtimes of the second and third function instances 116, 118. The profiler 120 may further query architecture information of the underlying hardware of the second execution server 114 and store the architecture information in association with an identifier (e.g., IP address) of the second execution server 114. The profiler 120 may store performance metrics (e.g., normalized values of counters) of the second function instances 116 as the second function profile 120a. The profiler 112 may store performance metrics of the third function instances 118 as the third function profile 120b. The profiler 120 may store hardware specific data of the second execution server 114 as the second hardware profile 120c. The performance metrics of the profiler 120 may be identified and determined similarly to as described above with respect to profiler 112.

The first and second execution servers 106, 114 may communicate with the profile server 102. The first and second execution servers 106, 114 may send profile and architecture data 122, 124 to the profile server 102. That is, the first function profile 112a, the second function profile 112b, the first hardware profile 112c, the second function profile 120a, the third function profile 120b and the second hardware profile 120c may be transmitted to the profile server 102. In some embodiments, the first and second execution servers 106, 114 may send profile and architecture data 122, 124 at periodic intervals to continuously update the profile server 102.

The profile server 102 may include a first function code service 126, second function code service 128 and third function code service 130 that aggregate profile data of the first, second and third functions respectively. As illustrated, the first function code service 126 may aggregate data of the first function profile 112a to generate aggregated profile data 126a. In this particular example, the aggregated profile data 126a may aggregate data of the first function profile 112a, for example over a certain time period that includes several updates to the first function profile 112a. In this example, the performance metrics (e.g., values of counters and/or normalized counters) of the aggregated profile data 126a do not meet a threshold (e.g., is determined not to be a hot spot and/or a number of invocations of the first function is below a threshold), and thus the first function code service 126 does not compile the first function code 126b.

In some embodiments as described herein, the threshold may be dynamically set for each function and may be based on a number of invocations needed to outweigh the costs of compilation. For example, the threshold for the first function may be based on an estimation of cost (e.g., latency and/or computing resources) to compile the first function code 126b and/or a cost savings associated with execution of the compiled code. For example, a predicted cost savings (e.g., reduction in latency and/or computing resources) associated with the first function code 126b may be determined. The cost savings may be the difference between the cost to execute the function code 126b without compilation and the cost to execute the function code 126b. If the cost savings are greater than the cost of compilation over some number of invocations, then the first function may be compiled. Thus, the threshold may be a number of invocations at which point the cost savings of the number of invocations are greater than the costs to compile. The other threshold for the second and third functions may be similarly set.

The second function code service 128 may aggregate the second function profile 112b from the first execution server 106 and the second function profile 120a of the second execution server 114 to generate aggregated profile data 128a. For example, the second function code service 128 may add values of counters and/or normalized counters.

For example, suppose that the profiler 112 includes a first loop backedge counter that counts how many times a loop backedge was taken during execution of the second function on the first execution server 106. Suppose further that the profiler 120 includes a second loop backedge counter that counts how many times the same loop backedge was taken during execution of the second function on the second execution server 114. The profile server 102 may aggregate (e.g., sum) the values of the first and second loop backedge counters and based on an identification that the values are associated with (e.g., measure and/or count) how many times a same (or functionally identical) portion of the second function executed. For example, the values may be extracted from the second function profile 112b and the second function profile 120a, that are transmitted to the profile server 102, and added together. Thus, the second function code service 128 may aggregate values associated with execution of the second function across a server array (a plurality of servers) and store the aggregated values as the aggregated profile data 128a.

The second function code service 128 may aggregate the counts associated with the second function, and determine that at least one of the aggregated counts meets a threshold (e.g., is a hot spot and/or a number of invocations of the second function is above a threshold). The threshold may be set as described above with respect to the first function. In response to at least one of the aggregated counts meeting the threshold, second function code 128d may be compiled to compile the second function 136.

The second function code 128d may be compiled for a specific target architecture. For example, the second function code service 128 may identify the first and second hardware profiles 112c, 120c from the transmissions of the first and second execution servers 106, 114, and that the first and second hardware profiles 112c, 120c are different from each other. Thus, the second function code service 128 may compile the second function code 128d so that the second function code 128d is compiled for two different architectures.

In this particular example, the second function code service 128 compiles the second function 136 based on the first hardware profile 112c to generate the first architecture function code 128b. The first architecture function code 128b may be targeted for the first execution server 106 and is designed to execute on the particular hardware (e.g., processor and/or accelerators) of the first execution server 106.

Furthermore, the second function code service 128 compiles the second function 136 based on the second hardware profile 120c to generate the second architecture function code 128c. The second architecture function code 128c may be targeted for the second execution server 114, and may be different than the first architecture function code 128b. The second architecture function code 130b may be designed to execute on the particular hardware of the second execution server 114.

Thus, even though the first and second architecture function code 128b, 128c may be functionally equivalent to the second function, the first and second architecture function code 128b, 128c may be compiled different based on the different underlying target hardware. As such, the profile server 102 may be compile code differently for different target architectures.

The memory layout of the second function code service 128 and the profile server 102 may be different from the first execution server 106 and the second execution server 114 (even if they use the same image of the second function). Thus, some embodiments of the profile server 102 remove the process dependent information in the first architecture function code 128b and second architecture function code 128c before sending the first architecture function code 128b and the second architecture function code 128c to the first and second execution servers 106, 114.

Similarly, the third function code service 130 may aggregate data of the third function profile 120b over a time period to generate aggregated profile data 130a. The performance metrics of the aggregated profile data 130a may indicate that the third function meets a threshold (e.g., is a hot spot and/or a number of invocations of the third function is above a threshold) and should therefore be compiled. The threshold may be set as described above with respect to the first function. Thus, the profile server 102 may compile the third function 138. That is, the third function code service 130 may compile the third function code 130c based on the second hardware profile 120c. The profile server 102 may generate a second architecture function code 130b that corresponds to (e.g., implements) the third function. Process dependent information may be removed from the second architecture function code 130b.

The profile server 102 may send (e.g., propagate) the first architecture function code 128b, 132 that corresponds to the second function, to the first execution server 106. The first execution server 106 may implement the first architecture function code 128b to execute the second function after the first architecture function code 132 is received, thus reducing latency and computing resources. The profile server 102 may identify an identifier (e.g., IP address) of the first execution server 106 from the first hardware profile 112c, and communicate with the first execution server 106 based on the identifier. In some embodiments, the profiler 112 may store and maintain the first architecture function code 128b.

The profile server 102 may also send the second architecture function codes 128c, 130b, 134 to the second execution server 114. The second execution server 114 may then implement the second architecture function code 128c, that corresponds to the second function, to execute the second function. The second execution server 114 may further implement the second architecture function code 130b, that corresponds to the third function, to execute the third function. Thus, execution of the second and third functions may be performance enhanced and resource usage may be reduced. The profile server 102 may identify an identifier (e.g., IP address) of the second execution server 114 from the second hardware profile 120c, and address communications to the identifier. In some embodiments, the profiler 120 may store and maintain the second architecture function codes 128c, 130b.

In some embodiments, the profile server 102 may de-compile compiled code if a corresponding function is cold. For example, suppose that the profile server 102 identifies that counters of the aggregated profile data 130a have fallen below another threshold that corresponds to a cost associated with storing and/or maintaning the second architecture function code 130b. Third function code service 130 may de-compile the second architecture function code 130b to reduce computing resources (e.g., memory).

Thus, the first and second execution servers 106, 114 may communicate with the profile server 102, and particularly with the first function code service, 126, second function code service 128, and third function code service 130 to send first function profile 112a, second function profile 112b, second function profile 120a, third function profile 120b, first hardware profile 112c and second hardware profile 120c. In some embodiments, the profilers 112, 120 may periodically provide the first function profile 112a, second function profile 112b, second function profile 120a, third function profile 120b, first hardware profile 112c and second hardware profile 120c to the first function code service, 126, the second function code service 128, and the third function code service 130. In some embodiments, each of the first and second execution servers 106, 114 may include only one profiler 112, 120 (e.g., a “Profile Local Service”).

In some embodiments, function services may be implemented. The function services may be runtimes brought up to run service functions, such as first function instances 108, second function instances 110, second function instances 116 and third function instances 118. The function services may also respond to user requests. The function services may be functional as runtimes in FaaS systems. The profilers 112, 120 may each communicate with multiple function service instances running in the first and second execution servers 106, 114 depending on service request concurrency.

The profile server 102 may implement code service that is a dedicated code service to receive and aggregate profile metrics across a server array, which in this example includes the first and second execution servers 106, 114. When the performance metrics of a respective function reach a threshold, the profile server 102 may compile the respective function code and provide the compiled code to the server array. The profile server 102 may be a dedicated server within the server array that is dedicated to aggregating performance metrics, identifying when the performance meets a threshold, compiling the function code and transmitting the function code.

In some embodiments, each function has only one corresponding code service on the profile server 102 that aggregates performance metrics of the function, compiles the code of the function and transmits the compiled code. For example, the first function may correspond to only the first function code service 126, the second function may correspond to only the second function code service 128, and the third function may correspond to only the third function code service 130. In some embodiments, the profile server 102 may also execute functions (e.g., the first, the second and/or the third functions) in addition to executing the first function code service 126, the second function code service 128, and the third function code service 130. In some embodiments, each of the first function code service 126, the second function code service 128, and the third function code service 130 implement JIT compilation of the respective first function code 126b, the second function code 128d and the third function code 130c.

Thus, some embodiments may employ JIT compilation, dynamic translation and/or run-time compilations to execute computer code that involves compilation during execution of a program at run time rather than prior to execution. Most often, such compilation may include source code and/or bytecode translation to machine code, which is then executed directly. A system implementing a JIT compiler may continuously analyze the code being executed and identify parts of the code where the speedup gained from compilation or recompilation would outweigh the overhead of compiling that code.

In some examples, functions may not be compiled the first time the functions are called. For example, and for each function, a virtual machine may maintain an invocation count, which starts at a predefined compilation threshold value and is decremented every time the method is called. When the invocation count reaches zero, a just-in-time compilation for the method is triggered. Therefore, often-used methods are compiled soon after the virtual machine has started, and less-used methods are compiled much later, or not at all. Some embodiments may utilize such metrics to determine which functions to compile, and which functions should not be compiled. Thus, some embodiments may reduce operation time of functions while reducing resource usage. It is worth noting that any number of computing devices may provide performance metrics and receive compiled code from the profile server 102.

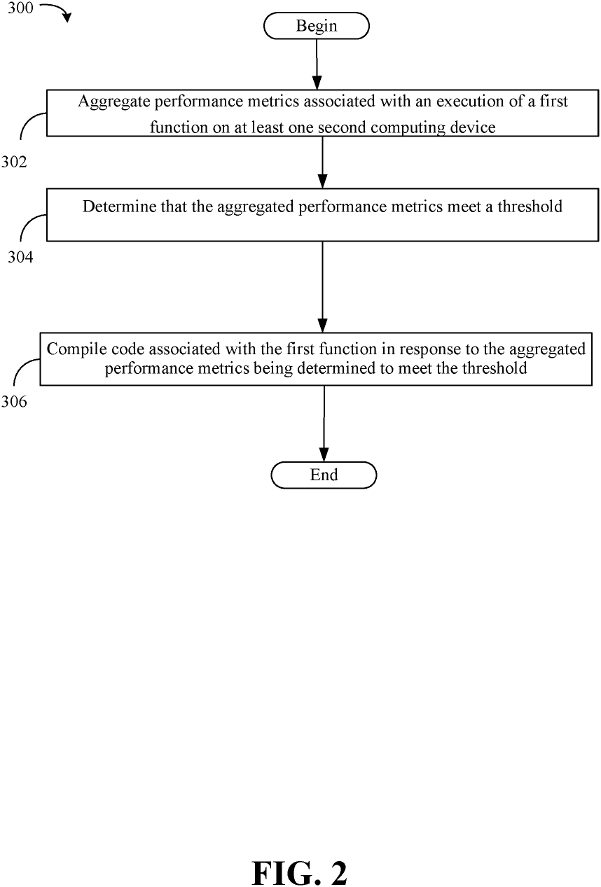

FIG. 2 shows a method 300 of enhanced code compilation associated with a first computing device and based on performance metrics from a server array. The method 300 may generally be implemented in a server, such as, for example, the first execution server 106, the second execution server 114 and/or the profile server 102 (FIG. 1), already discussed. More particularly, the method 300 may be implemented as one or more modules in a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), FPGAs, complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 300 may be written in any combination of one or more programming languages, including an object oriented programming language such as JAVA, SMALLTALK, C++ or the like, the dynamically typed languages such as JAVASCRIPT or PYTHON, as well as conventional procedural programming languages, such as the “C” programming language or similar programming languages. Additionally, logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 302 aggregates performance metrics associated with an execution of a first function on at least one second computing device. Illustrated processing block 304 determines that the aggregated performance metrics meet a threshold. Illustrated processing block 306 compiles code associated with the first function in response to the aggregated performance metrics being determined to meet the threshold.

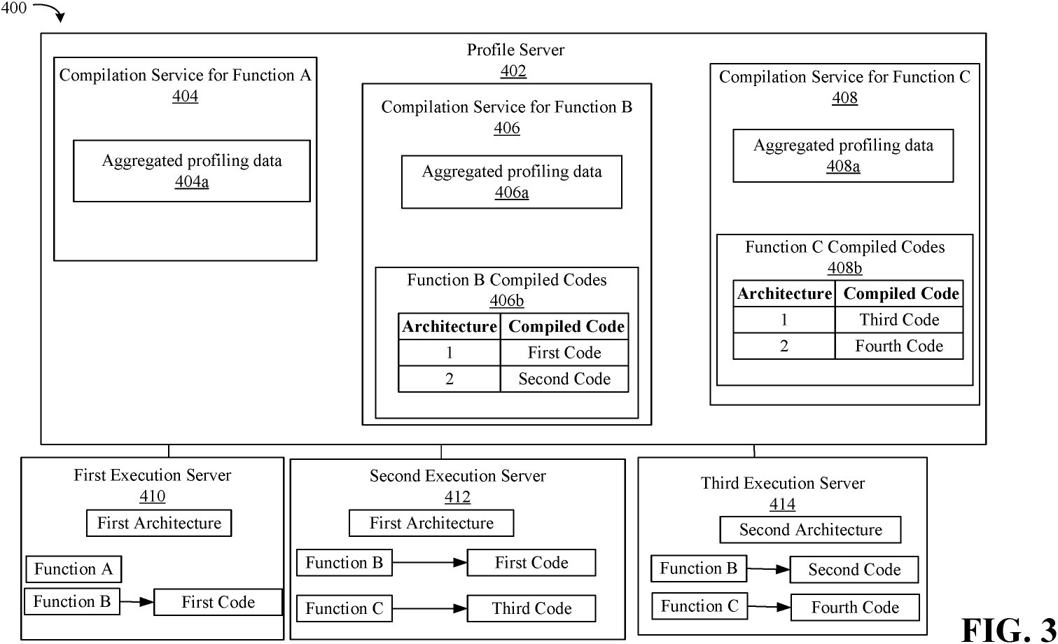

FIG. 3 illustrates a computing architecture 400 that includes a profile server 402 and a server array that includes first-third execution servers 410, 412, 414. The computing architecture 400 may be used in conjunction with the process 100. For example, the profiler server 402 may be the profile server 102 of FIG. 1, and the first-third execution servers 410, 412, 414 may be part of the server array of FIG. 1.

In this particular example, the compilation service (which may correspond to JIT function code service) for function A 404 does not compile function A based on the aggregated profiling 404a data. In contrast, compilation service for function B 406 service (which may correspond to JIT function code service) may aggregate performance metrics of function B and determine that function B should be compiled based on the aggregated profiling data 406a. Thus, compilation service for function B 406 compiles function B based on first and second architectures.

The first execution server 410 has the first architecture, the second execution server 412 has the first architecture and the third execution server 414 has the second architecture. Thus, the first and second execution servers 410, 412 have the same type of architecture (first architecture), while the third execution server 414 has a different architecture (second architecture). The compiled codes may be stored in the function B compiled codes 406b (e.g., a data structure) and in conjunction with the corresponding architecture that the compiled code is to execute upon. Thus, first code of the function B compiled codes 406b may be designed for the first architecture, while the second code of the function B compiled codes 406b may be designed for the second architecture.

Similarly, the compilation service for function C 408 service (which may correspond to JIT compiler function code service) may determine that function C is to be compiled based on the aggregated profiling data 408a. Thus, the function C compiled codes 408b may include the third code and the fourth code. That is, the compiled codes may be stored in the function C compiled codes 408b (e.g., a data structure) and in conjunction with the corresponding architecture that the compiled code is to execute upon. Thus, third code of the function C compiled codes 408b may be designed for the first architecture, while the second code of the function C compiled codes 408b may be designed for the second architecture.

In this example, each respective server of the first, second and third execution servers 410, 412, 414 may receive code designed for the specific architecture of the respective execution server. Thus, the first execution server 410 may receive the first code to execute function B since the first execution server 410 has the first architecture. The second execution server 412 may similarly receive the first function code since the second execution server 412 has the same first architecture as the first execution server 410. Additionally, the second execution server 412 may receive the third code to execute function C. The third execution server 414 may receive the second and fourth codes to execute functions B and C.

In some embodiments, the profile server 402 may target transmission based on the specific underlying architecture of first-third execution servers 410, 412, 414. For example, the first execution server 410 may only receive relevant compiled codes that pertain to functions that the first execution server 410 will execute, and specifically for the first architecture. For example, the profile server 402 may transmit the first code to the first execution server 410 but not the second, third and fourth codes.

In some embodiments, each compilation service of the compilation service for function A 404, compilation service for function B 406 and the compilation service for function C 408 may be started right after a corresponding function service image of function A, function B and function C is deployed, and before any requests (e.g., requests for compiled code) are received. During startup of the compilation service for function A 404, compilation service for function B 406 and the compilation service for function C 408, all files (e.g., class or jar files) from the image of the function A, function B and function C (e.g., FaaS workload) are loaded.

In some embodiments, each of the first, second and third executions servers 410, 412, 414 may have profilers that profile function A, function B or function C. The profilers may initially enter an idle state while listening to requests from local services for profiling data uploads and requests for downloading of cached compiled code from the profile server 402. The profilers may provide aggregated data to the profile server 402. The aggregated data may correspond to the aggregated profiling data 404a, 406a, 406c.

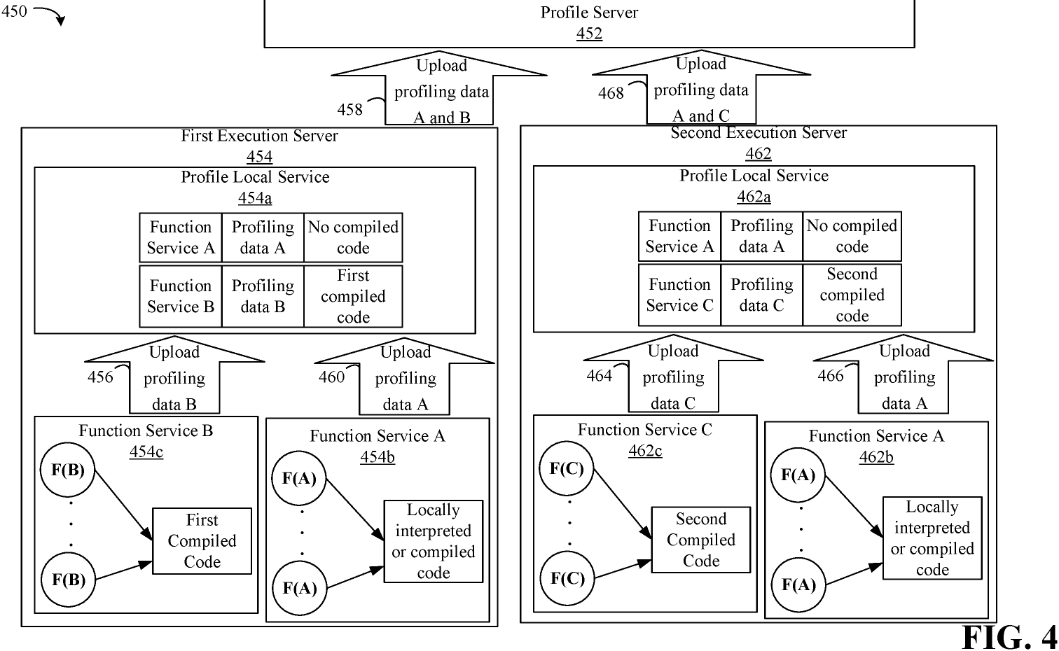

FIG. 4 illustrates a process 450 of tracking and uploading profiling data. The elements of FIGS. 1 and 3 may be used in conjunction with and/or in place of any of the elements describes herein. For example, the profiler server 452 may be the profile server 102 of FIG. 1, and the first and second execution servers 454, 462 may be part of the server array of FIG. 1.

In detail, a first execution server 454 includes a profile local service 454a. The profile local service 454a may have function services A and B. Function service A may include profiling data of function A. Function A may not include compiled code. Function service B may include profiling data B and first compiled code of function B. The profile server 452 may have generated the first compiled code and provided the first compiled code to the first execution server 454. The profile server 452 may have determined that function B is to be compiled based on aggregate profiling data from profile local services 454a, 462a to run JIT tasks. The first compiled code of the function B may then be stored by the profile local service 454a. The profile local service 454a may determine, store and transmit hardware profiles of the first execution server 454.

Every time function service B calls function B, each instance of function B may implement the first compiled code. For example, the profile local service 454a may provide the first compiled code to the function service B 454c. The function service B 454c may maintain counters and track execution of instances of function B to generate profiling data B and upload the profiling data B 456 to the profile local service 454a at predetermined intervals and/or in response to a completion of an instance of function B.

When function service A 454b calls function A, function A may be interpreted or compiled. It is worthwhile to note that the function A may not be fully optimized since function A may not execute as often function B. Thus, less resources may be utilized to generate compiled or interpreted code of function A, as opposed to function B that may be enhanced further than function A. The function service A 454b may maintain counters and track execution of instances of function A to generate profiling data A and upload the profiling data A 460 to the profile local service 454a at predetermined intervals and/or in response to a completion of an instance of function A. The profile local service 454a may upload profiling data A and B 458 to profile server 452.

The second execution server 462 may similarly include profile local service 462a. The profile local service 462a may have second compiled code for function C. The profile server 452 may have generated the second compiled code and transmitted the second compiled code to the second execution server 462. The function service C 462c may therefore implement each instance of function C based on the second compiled code. Function service C may upload profiling data C 464 to the profile local service 462a. Function A may not have compiled code. Thus, when function service A 462b calls function A, function A may be interpreted or compiled. It is worthwhile to note that the function A may not be fully optimized since function A may not execute as often function C. Thus, less resources may be utilized to generate compiled code of function A, as opposed to function C that may be enhanced further than function A.

Function services A and C 462c, 462b may maintain counters and track execution of instances of functions A and C to generate profiling data A and profiling data C. Function services A and C 462c, 462b may upload the profiling data A and C 466, 464 to the profile local service 462a at predetermined intervals and/or in response to a completion of an instance of function A and/or function C. The profile local service 462a may upload profiling data A and C to profile server 468. The profile local service 462a may determine, store and transmit hardware profiles of the second execution server 462.

The profile local services 454a, 462a may upload the profiling data of the profile local service 454a, 462a and architecture information of the first and second execution server 454, 462 to the profile server 452 periodically (e.g., every one minute). The profile server 452 may aggregate profiling data to determine whether to compile code of the functions A, B, C and propagate the compiled code.

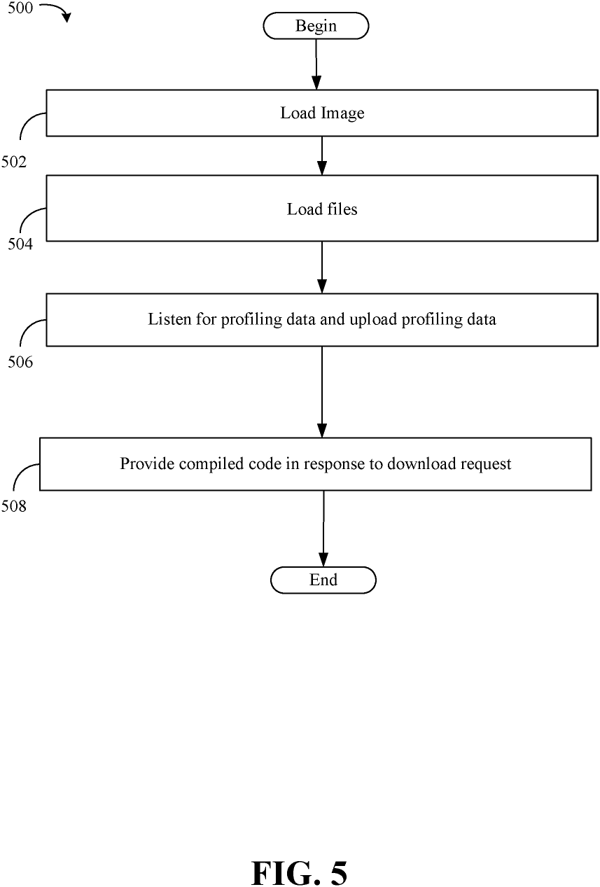

FIG. 5 shows a method 500 of implementing a function code service. The method 500 may generally be implemented in a server such as, for example, the profile server 102 (FIG. 1), the profile server 402 (FIG. 3), the profile server 452 (FIG. 4) and/or with any of the processes and methods, such as process 100 (FIG. 1), method 300 (FIG. 2) and process 450 (FIG. 4) already discussed. More particularly, the method 500 may be implemented as one or more modules in a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 502 loads an image of a function into the function code service. In illustrated processing block 504 files (e.g., class or jar files) of the image are loaded. In some embodiments, the function code service may enter an idle state, while listening for requests from profile local service for profiling data uploads and requests for downloading cached compiled code. Illustrated processing block 506 listens for profiling data and uploads profiling data. Illustrated processing block 508 provides compiled code in response to a download request from an execution server.

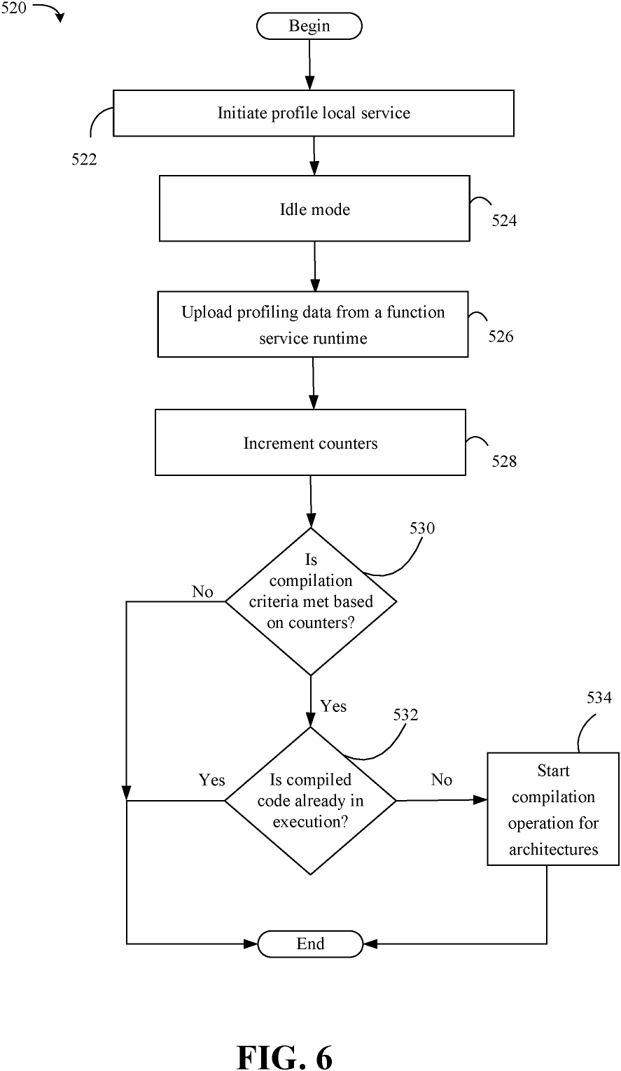

FIG. 6 shows a method 520 of uploading profiling data and compiling a function. The method 520 may generally be implemented in a server such as, for example, the profile server 102 (FIG. 1), the profile server 402 (FIG. 3), the profile server 452 (FIG. 4) and/or with any of the processes and methods, such as process 100 (FIG. 1), method 300 (FIG. 2), process 450 (FIG. 4) and method 500 (FIG. 5) already discussed. More particularly, the method 520 may be implemented as one or more modules in a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 522 initiates a profile local service. Illustrated processing block 524 enters an idle mode while listening to requests from the local profile service. Illustrated processing block 526 uploads profiling data from a function service runtime. Illustrated processing block 528 increments counters based on the profiling data. Illustrated processing block 530 determines whether a compilation criteria (e.g., corresponding to a function) is met based on counters. If so, illustrated processing block 532 determines if the compiled code for the function is already in execution. If so, the method 520 may end. Otherwise, illustrated processing block 534 may start compilation operation for architectures that execute the function. In some embodiments, processing block 530 may return to processing block 524 if the compilation criteria is not met to iterate through method 520. In some embodiments, processing block 532 may return to processing block 524 if the compiled code is in execution to iterate through method 520. In some embodiments, processing block 534 may return to processing block 524 to iterate through method 520.

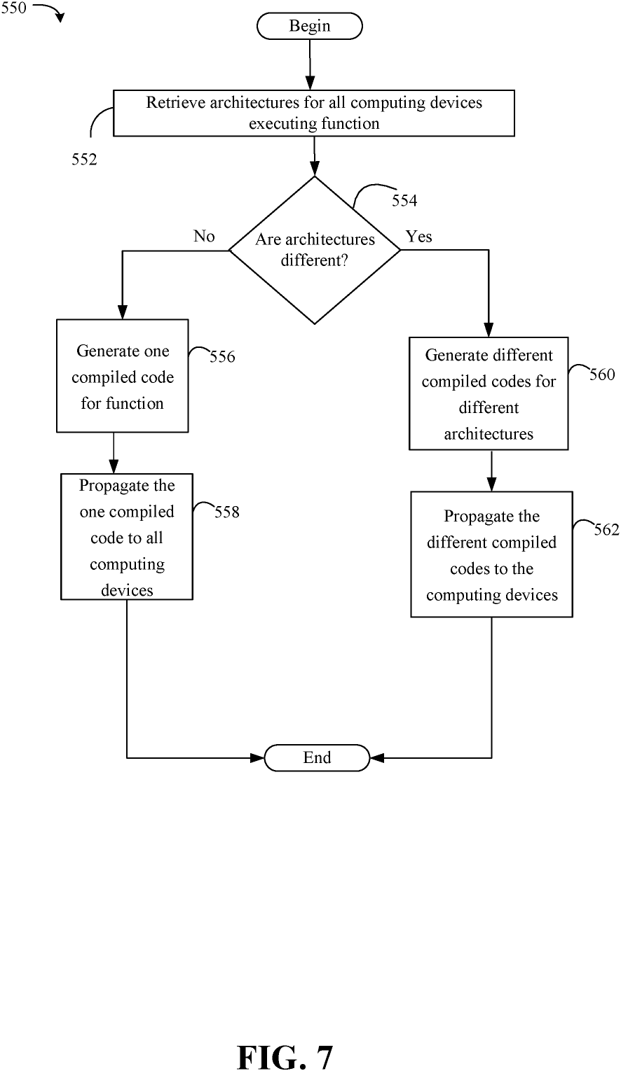

FIG. 7 shows a method 550 of generating compiled codes for one or more computing architectures. The method 550 may generally be implemented in a server such as, for example, the profile server 102 (FIG. 1), the profile server 402 (FIG. 3), the profile server 452 (FIG. 4) and/or with any of the processes and methods, such as process 100 (FIG. 1), method 300 (FIG. 2), process 450 (FIG. 4), method 500 (FIG. 5), and method 520 (FIG. 6) already discussed. More particularly, the method 550 may be implemented as one or more modules in a set of logic instructions stored in a machineor computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 552 retrieves architectures for all computing devices (e.g., servers) executing a function that is to be compiled. Illustrated processing block 554 determines if the architectures are different. If so, illustrated processing block 560 generates different compiled codes for different architectures. Illustrated processing block 562 propagates the different compiled codes to the computing devices.

If processing block 554 determines that the architectures are the same, illustrated processing block 556 generates one compiled code for the architectures. Illustrated processing block 558 propagates the one compiled code to the computing devices.

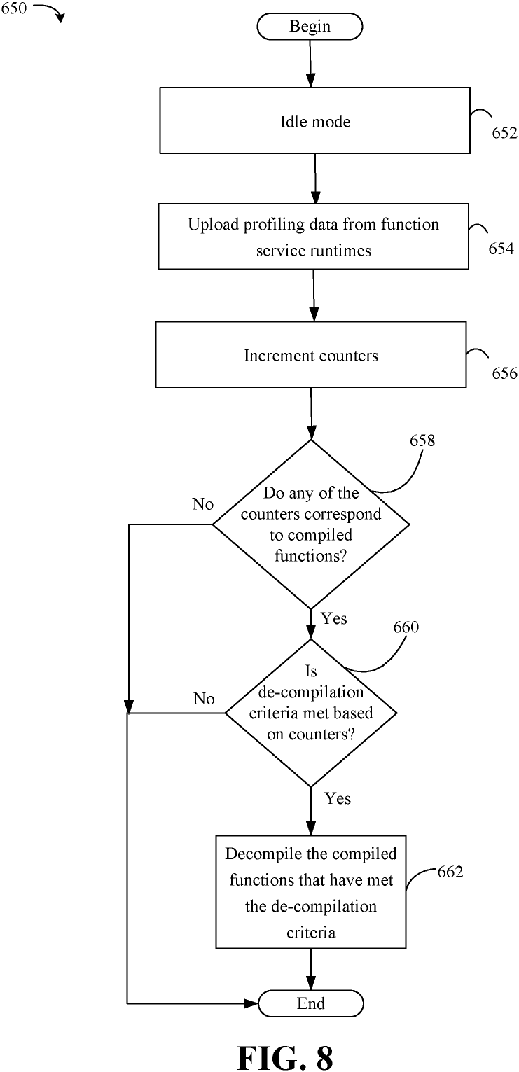

FIG. 8 shows a method 650 of de-compiling compiled codes. The method 650 may generally be implemented in a server such as, for example, the profile server 102 (FIG. 1), the profile server 402 (FIG. 3), the profile server 452 (FIG. 4) and/or with any of the processes and methods, such as process 100 (FIG. 1), method 300 (FIG. 2), process 450 (FIG. 4), method 500 (FIG. 5), method 520 (FIG. 6), and method 550 (FIG. 7) already discussed. More particularly, the method 650 may be implemented as one or more modules in a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 652 enters an idle mode. Illustrated processing block 654 uploads profiling data from function service runtimes of functions. Illustrated processing block 656 increments corresponding counters of the functions. Illustrated processing block 658 determines if any of the counters correspond to compiled functions. If so, illustrated processing block 660 determines if a de-compilation criteria is met based on the counters (e.g., a function has turned “cold” and or a value of a counter has fallen below a threshold). If so, illustrated processing block 662 decompiles the compiled functions that have met the de-compilation criteria to reallocate computing resources. In some embodiments, method 650 may repeat from processing block 652 and after execution of one or more of processing blocks 652, 660, 658.

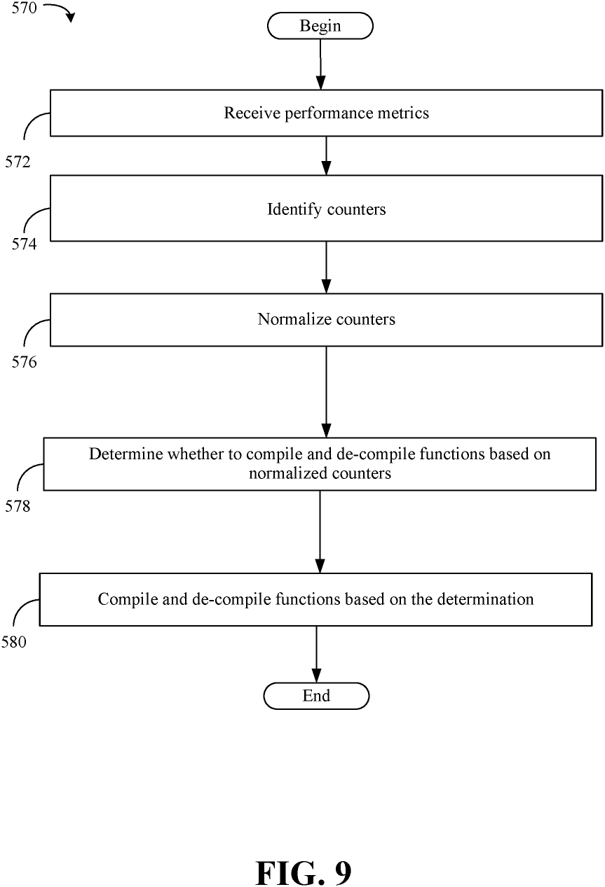

FIG. 9 shows a method 570 of normalizing counters. The method 570 may generally be implemented in a server such as, for example, the profile server 102 (FIG. 1), the profile server 402 (FIG. 3), the profile server 452 (FIG. 4) and/or with any of the processes and methods, such as process 100 (FIG. 1), method 300 (FIG. 2), process 450 (FIG. 4), method 500 (FIG. 5), method 520 (FIG. 7), method 550 (FIG. 7) and method 650 (FIG. 8) already discussed. More particularly, the method 570 may be implemented as one or more modules in a set of logic instructions stored in a machineor computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 572 receives performance metrics. Illustrated processing block 574 identifies counters. Illustrated processing block 576 normalizes the counters (e.g., a value of a counter may be divided by a time period that the counter has executed). Illustrated processing block 578 determines whether to compile and de-compile functions based on the normalized counters. Illustrated processing block 580 compiles and de-compiles functions based on the determination.

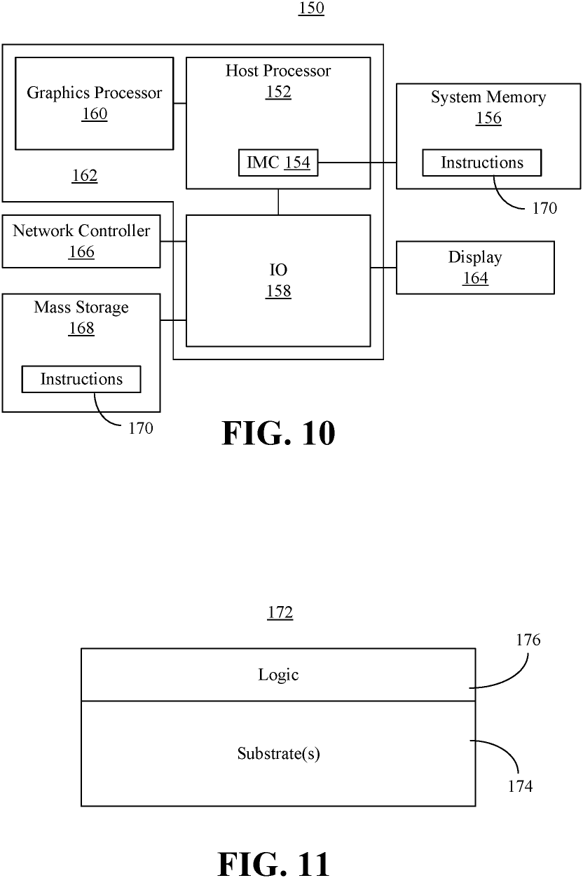

Turning now to FIG. 10, a performance-enhanced computing system 150 is shown. The system 150 may generally be implemented in a server such as, for example, the profile server 102 (FIG. 1), the profile server 402 (FIG. 3), the profile server 452 (FIG. 4) and/or execute any of the processes and methods described herein, such as process 100 (FIG. 1), method 300 (FIG. 2), process 450 (FIG. 4), method 500 (FIG. 5), method 520 (FIG. 6), method 550 (FIG. 7), method 650 (FIG. 8) and method 570 (FIG. 9) already discussed. The system 150 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), etc., or any combination thereof. In the illustrated example, the system 150 includes a host processor 152 (e.g., CPU) having an integrated memory controller (IMC) 154 that is coupled to a system memory 156.

The illustrated system 150 also includes an input output (IO) module 158 implemented together with the host processor 152 and a graphics processor 160 (e.g., GPU) on a semiconductor die 162 as a system on chip (SoC). The illustrated IO module 158 communicates with, for example, a display 164 (e.g., touch screen, liquid crystal display/LCD, light emitting diode/LED display), a network controller 166 (e.g., wired and/or wireless), and mass storage 168 (e.g., hard disk drive/HDD, optical disk, solid state drive/SSD, flash memory).

The host processor 152, the graphics processor 160 and/or the IO module 158 may execute instructions 170 retrieved from the system memory 156 and/or the mass storage 168. In an embodiment, the computing system 150 may receive performance metrics from at least one second computing device (e.g., other servers), and via the network controller 166. The computing system 150 may aggregate the performance metrics to generate aggregated performance metrics, determine that the aggregated performance metrics meet a threshold, and compile code associated with the first function in response to the aggregated performance metrics being determined to meet the threshold. The compiled code may be propagated to the at least one second computing device through the network controller 166. The at least one second computing device may execute the compiled code to implement the first function.

In some embodiments, the compiled code may be based on a computing architecture of the at least one second computing device. For example, the system 150 may identify a hardware profile of the at least one second computing device and compile the code associated with the first function based on the hardware profile to generate the compiled code.

The system 150 may identify at least one first performance metric, where the at least one first performance metric is associated with the execution of the first function on one computing device of the at least one second computing device. The system 150 may identify at least one second performance metric, where the at least one second performance metric is to be associated with the execution of the first function on another computing device of the at least one second computing device. The system 150 may aggregate the at least one first performance metric and the at least one second performance metric to generate the aggregated performance metrics.

In some embodiments, the system 150 may determine a number of invocations associated with execution of the first function based on the aggregated performance metrics, and in response to the number of invocations being determined to meet a threshold, compile the code associated with the first function to generate the compiled code.

Thus, the system 150 may enhance performance by identifying trends of ephemeral functions and compiling code accordingly. Latency to execute hot functions may be reduced while computing resources may be conserved by avoidance of compilation of cold functions. As such, system 150 efficiently utilizes computing resources while also reducing overall execution latency.

FIG. 11 shows a semiconductor apparatus 172 (e.g., chip, die, package) that may be part of a first computing device. The illustrated apparatus 172 includes one or more substrates 174 (e.g., silicon, sapphire, gallium arsenide) and logic 176 (e.g., transistor array and other integrated circuit/IC components) coupled to the substrate(s) 174. In an embodiment, the apparatus 172 is operated to compile logic and the logic 176 performs one or more aspects of the profile server 102 (FIG. 1), the profile server 402 (FIG. 3), the profile server 452 (FIG. 4) and/or execute any of the processes and methods described herein, such as process 100 (FIG. 1), method 300 (FIG. 2), process 450 (FIG. 4), method 500 (FIG. 5), method 520 (FIG. 6), method 550 (FIG. 7), method 650 (FIG. 8) and method 570 (FIG. 9) already discussed. Logic 176 may identify performance metrics. The performance metrics may be associated with execution of a first function on at least one second computing device. The logic 176 may aggregate the performance metrics to generate aggregated performance metrics. The logic 176 may determine that the aggregated performance metrics are to meet a threshold. The logic 176 may compile code associated with the first function in response to the aggregated performance metrics being determined to meet the threshold. Logic 176 may propagate the compiled code to the at least one second computing device.

The illustrated apparatus 172 is therefore considered to be performance-enhanced at least to the extent that it enables compilation output to automatically take advantage of performance metrics of FaaS functions distributed throughout a wide server array to determine whether to compile the functions, and the degree to which the functions should be enhanced for execution.

The logic 176 may be implemented at least partly in configurable logic or fixed-functionality hardware logic. In one example, the logic 176 includes transistor channel regions that are positioned (e.g., embedded) within the substrate(s) 174. Thus, the interface between the logic 176 and the substrate(s) 174 may not be an abrupt junction. The logic 176 may also be considered to include an epitaxial layer that is grown on an initial wafer of the substrate(s) 174.

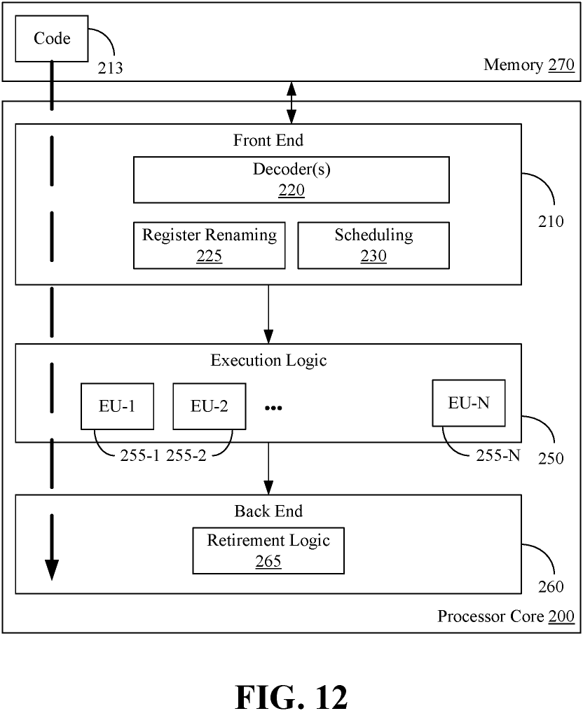

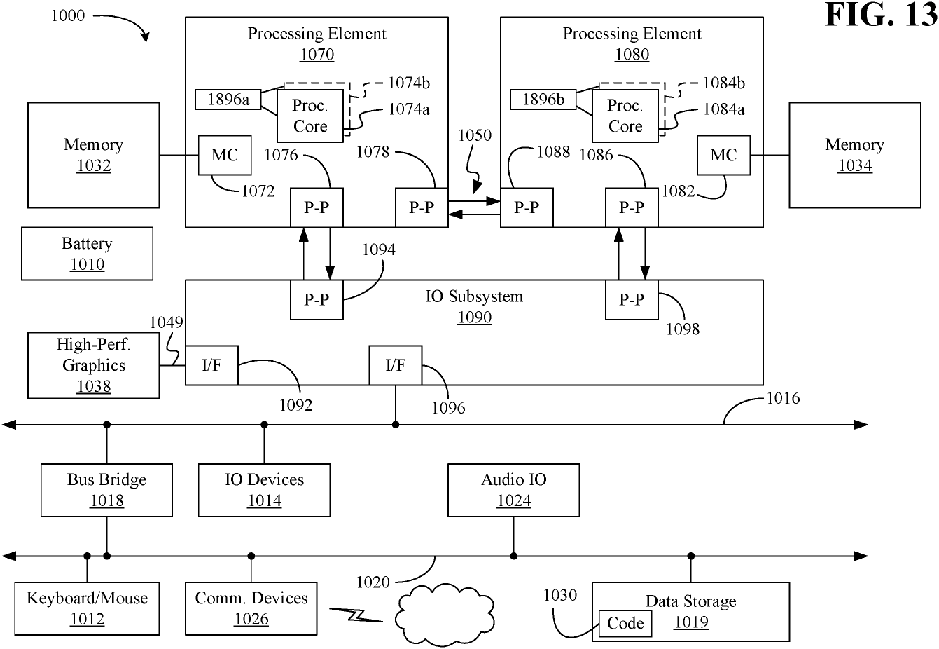

FIG. 12 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 12, a processing element may alternatively include more than one of the processor core 200 illustrated in FIG. 12. The processor core 200 may be a single-threaded core or, for at least one embodiment, the processor core 200 may be multithreaded in that it may include more than one hardware thread context (or “logical processor”) per core.

FIG. 12 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement any of the processes and methods described herein, such as process 100 (FIG. 1), method 300 (FIG. 2), process 450 (FIG. 4), method 500 (FIG. 5), method 520 (FIG. 6), method 550 (FIG. 7), method 650 (FIG. 8) and method 570 (FIG. 9) already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 12, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

Referring now to FIG. 13, shown is a block diagram of a computing system 1000 embodiment in accordance with an embodiment. Shown in FIG. 13 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 13 may be implemented as a multi-drop bus rather than point-to-point interconnect.

As shown in FIG. 13, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 12.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 13, MC’s 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 13, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 13, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement any of the processes and methods described herein, such as process 100 (FIG. 1), method 300 (FIG. 2), process 450 (FIG. 4), method 500 (FIG. 5), method 520 (FIG. 6), method 550 (FIG. 7), method 650 (FIG. 8) and method 570 (FIG. 9) already discussed. Further, an audio I/O 1024 may be coupled to second bus 1020 and a battery 1010 may supply power to the computing system 1000.

Note that other embodiments are contemplated. For example, instead of the point-to-point architecture of FIG. 13, a system may implement a multi-drop bus or another such communication topology. Also, the elements of FIG. 13 may alternatively be partitioned using more or fewer integrated chips than shown in FIG. 13.

### Additional Notes and Examples

Example 1 includes a first computing device comprising a network controller to receive performance metrics from at least one second computing device, the performance metrics to be associated with execution of a first function on the at least one second computing device, a graphics processor, a central processing unit, and a memory including a set of instructions, which when executed by one or more of the graphics processor or the central processing unit, cause the first computing device to aggregate the performance metrics, determine that the aggregated performance metrics meet a threshold, and compile code associated with the first function in response to the aggregated performance metrics being determined to meet the threshold.

Example 2 includes the first computing device of example 1, wherein the instructions, when executed, cause the first computing device to identify at least one first performance metric, wherein the at least one first performance metric is first number of invocations of the first function on one computing device of the at least one second computing device, identify at least one second performance metric, wherein the at least one second performance metric is a second number of invocations first function on another computing device of the at least one second computing device, and aggregate the at least one first performance metric and the at least one second performance metric to generate the aggregated performance metrics that are to correspond to the first and second number of invocations.

Example 3 includes the first computing device of example 1, wherein the instructions, when executed, cause the first computing device to determine the threshold based on a cost to compile the first function, determine a number of invocations associated with execution of the first function based on the aggregated performance metrics, and in response to the number of invocations being determined to meet the threshold, compile the code associated with the first function to generate the compiled code.

Example 4 includes the first computing device of example 1, wherein the instructions, when executed, cause the first computing device to propagate the compiled code to the at least one second computing device.

Example 5 includes the first computing device of example 4, wherein the at least one second computing device is to execute the compiled code.

Example 6 includes the first computing device of any one of examples 1-5, wherein the instructions, when executed, cause the first computing device to identify a hardware profile of the at least one second computing device, and compile the code associated with the first function based on the hardware profile to generate the compiled code.

Example 7 includes a semiconductor apparatus of a first computing device, comprising one or more substrates, and logic coupled to the one or more substrates, wherein the logic is implemented in one or more of configurable logic or fixed-functionality hardware logic, the logic coupled to the one or more substrates to aggregate performance metrics associated with an execution of a first function on at least one second computing device, determine that the aggregated performance metrics are to meet a threshold, and compile code associated with the first function in response to the aggregated performance metrics being determined to meet the threshold.

Example 8 includes the semiconductor apparatus of example 7, wherein the logic is to identify at least one first performance metric, wherein the at least one first performance metric is a first number of invocations of the first function on one computing device of the at least one second computing device, identify at least one second performance metric, wherein the at least one second performance metric is a second number of invocations of the first function on another computing device of the at least one second computing device, and aggregate the at least one first performance metric and the at least one second performance metric to generate the aggregated performance metrics that are to correspond to the first and second number of invocations.

Example 9 includes the semiconductor apparatus of example 7, wherein the logic is to determine the threshold based on a cost to compile the first function, determine a number of invocations associated with execution of the first function based on the aggregated performance metrics, and in response to the number of invocations being determined to meet the threshold, compile the code associated with the first function to generate the compiled code.

Example 10 includes the semiconductor apparatus of example 7, wherein the logic is to propagate the compiled code to the at least one second computing device.

Example 11 includes the semiconductor apparatus of example 7, wherein the at least one second computing device is to execute the compiled code.

Example 12 includes the semiconductor apparatus of any one of examples 7-11, wherein the logic is to identify a hardware profile of the at least one second computing device, and compile the code associated with the first function based on the hardware profile to generate the compiled code.

Example 13 includes the semiconductor apparatus of any one of examples 7-11, wherein the logic coupled to the one or more substrates includes transistor channel regions that are positioned within the one or more substrates.

Example 14 includes at least non-transitory one computer readable storage medium comprising a set of instructions, which when executed by a first computing device, cause the first computing device to aggregate performance metrics associated with an execution of a first function on at least one second computing device, determine that the aggregated performance metrics are to meet a threshold, and compile code associated with the first function in response to the aggregated performance metrics being determined to meet the threshold.

Example 15 includes the at least one non-transitory computer readable storage medium of example 14, wherein the instructions, when executed, cause the first computing device to identify at least one first performance metric, wherein the at least one first performance metric is a first number of invocations of the first function on one computing device of the at least one second computing device, identify at least one second performance metric, wherein the at least one second performance metric is a second number of invocations of the first function on another computing device of the at least one second computing device, and aggregate the at least one first performance metric and the at least one second performance metric to generate the aggregated performance metrics that are to correspond to the first and second number of invocations.

Example 16 includes the at least one non-transitory computer readable storage medium of example 14, wherein the instructions, when executed, cause the first computing device to determine the threshold based on a cost to compile the first function, determine a number of invocations associated with execution of the first function based on the aggregated performance metrics, and in response to the number of invocations being determined to meet the threshold, compile the code associated with the first function to generate the compiled code.

Example 17 includes the at least one non-transitory computer readable storage medium of example 14, wherein the instructions, when executed, cause the first computing device to propagate the compiled code to the at least one second computing device.

Example 18 includes the at least one non-transitory computer readable storage medium of example 14, wherein the at least one second computing device is to execute the compiled code.

Example 19 includes The at least one non-transitory computer readable storage medium of any one of examples 14-18, wherein the instructions, when executed, cause the first computing device to identify a hardware profile of the at least one second computing device, and compile the code associated with the first function based on the hardware profile to generate the compiled code.

Example 20 includes a method associated with a first computing device, comprising aggregate performance metrics associated with an execution of a first function on at least one second computing device, determining that the aggregated performance metrics meet a threshold, and compiling code associated with the first function in response to the aggregated performance metrics being determined to meet the threshold.

Example 21 includes the method of example 20, further comprising identifying at least one first performance metric, wherein the at least one first performance metric is a first number of invocations of the first function on one computing device of the at least one second computing device, identifying at least one second performance metric, wherein the at least one second performance metric is a second number of invocations of the first function on another computing device of the at least one second computing device, and aggregating the at least one first performance metric and the at least one second performance metric to generate the aggregated performance metrics that are to correspond to the first and second number of invocations.

Example 22 includes the method of example 20, further comprising determining the threshold based on a cost to compile the first function, determining a number of invocations associated with execution of the first function based on the aggregated performance metrics, and in response to the number of invocations being determined to meet a threshold, compiling the code associated with the first function to generate the compiled code.

Example 23 includes the method of example 20, further comprising propagating the compiled code to the at least one second computing device.

Example 24 includes the method of example 20, wherein the at least one second computing device is to execute the compiled code.

Example 25 includes the method of any one of examples 20-24, further comprising identifying a hardware profile of the at least one second computing device, and compiling the code associated with the first function based on the hardware profile to generate the compiled code.

Example 26 includes a semiconductor apparatus of a first computing device, comprising means for aggregate performance metrics associated with an execution of a first function on at least one second computing device, means for determining that the aggregated performance metrics meet a threshold, and means for compiling code associated with the first function in response to the aggregated performance metrics being determined to meet the threshold.

Example 27 includes the semiconductor apparatus of example 26, further comprising means for identifying at least one first performance metric, wherein the at least one first performance metric is a first number of invocations of the first function on one computing device of the at least one second computing device, means for identifying at least one second performance metric, wherein the at least one second performance metric is a second number of invocations of the first function on another computing device of the at least one second computing device, and means for aggregating the at least one first performance metric and the at least one second performance metric to generate the aggregated performance metrics that are to correspond to the first and second number of invocations.

Example 28 includes the semiconductor apparatus of example 26, further comprising means for determining the threshold based on a cost to compile the first function, means for determining a number of invocations associated with execution of the first function based on the aggregated performance metrics, and means for in response to the number of invocations being determined to meet a threshold, compiling the code associated with the first function to generate the compiled code.

Example 29 includes the semiconductor apparatus of example 26, further comprising means for propagating the compiled code to the at least one second computing device.

Example 30 includes the semiconductor apparatus of example 26, wherein the at least one second computing device is to execute the compiled code.

Example 31 includes the semiconductor apparatus of any one of example 26-30, further comprising means for identifying a hardware profile of the at least one second computing device, and means for compiling the code associated with the first function based on the hardware profile to generate the compiled code.

Thus, technology described herein may provide for an enhanced compilation system for FaaS architectures and designs. Embodiments described herein may reduce latency to execute functions and also reduce computer resource usage, while also implementing an enhanced system to track FaaS functions and performance metrics for accurate analysis.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1-25. (canceled)

26. A first computing device comprising:
a network controller to receive performance metrics from at least one second computing device, the performance metrics to be associated with execution of a first function on the at least one second computing device;
a graphics processor;
a central processing unit; and
a memory including a set of instructions, which when executed by one or more of the graphics processor or the central processing unit, cause the first computing device to:
aggregate the performance metrics,
determine that the aggregated performance metrics meet a threshold, and
compile code associated with the first function in response to the aggregated performance metrics being determined to meet the threshold.

27. The first computing device of claim 26, wherein the instructions, when executed, cause the first computing device to:
identify at least one first performance metric, wherein the at least one first performance metric is a first number of invocations of the first function on one computing device of the at least one second computing device;
identify at least one second performance metric, wherein the at least one second performance metric is a second number of invocations of the first function on another computing device of the at least one second computing device; and
aggregate the at least one first performance metric and the at least one second performance metric to generate the aggregated performance metrics that are to correspond to the first and second number of invocations.

28. The first computing device of claim 26, wherein the instructions, when executed, cause the first computing device to:
determine the threshold based on a cost to compile the first function;
determine a number of invocations associated with execution of the first function based on the aggregated performance metrics; and
in response to the number of invocations being determined to meet the threshold, compile the code associated with the first function to generate the compiled code.

29. The first computing device of claim 26, wherein the instructions, when executed, cause the first computing device to:
propagate the compiled code to the at least one second computing device.

30. The first computing device of claim 29, wherein the at least one second computing device is to execute the compiled code.

31. The first computing device of claim 26, wherein the instructions, when executed, cause the first computing device to:
identify a hardware profile of the at least one second computing device; and
compile the code associated with the first function based on the hardware profile to generate the compiled code.

32. A semiconductor apparatus of a first computing device, comprising:
one or more substrates; and
logic coupled to the one or more substrates, wherein the logic is implemented in one or more of configurable logic or fixed-functionality hardware logic, the logic coupled to the one or more substrates to:
aggregate performance metrics associated with an execution of a first function on at least one second computing device;
determine that the aggregated performance metrics are to meet a threshold; and
compile code associated with the first function in response to the aggregated performance metrics being determined to meet the threshold.

33. The semiconductor apparatus of claim 32, wherein the logic is to:
identify at least one first performance metric, wherein the at least one first performance metric is a first number of invocations of the first function on one computing device of the at least one second computing device;
identify at least one second performance metric, wherein the at least one second performance metric is a second number of invocations of the first function on another computing device of the at least one second computing device; and
aggregate the at least one first performance metric and the at least one second performance metric to generate the aggregated performance metrics that are to correspond to the first and second number of invocations.

34. The semiconductor apparatus of claim 32, wherein the logic is to:
determine the threshold based on a cost to compile the first function;
determine a number of invocations associated with execution of the first function based on the aggregated performance metrics; and
in response to the number of invocations being determined to meet the threshold, compile the code associated with the first function to generate the compiled code.

35. The semiconductor apparatus of claim 32, wherein the logic is to:
propagate the compiled code to the at least one second computing device.

36. The semiconductor apparatus of claim 32, wherein the at least one second computing device is to execute the compiled code.

37. The semiconductor apparatus of claim 32, wherein the logic is to:
identify a hardware profile of the at least one second computing device; and
compile the code associated with the first function based on the hardware profile to generate the compiled code.

38. The semiconductor apparatus of claim 32, wherein the logic coupled to the one or more substrates includes transistor channel regions that are positioned within the one or more substrates.

39. At least one non-transitory computer readable storage medium comprising a set of instructions, which when executed by a first computing device, cause the first computing device to:
aggregate performance metrics associated with an execution of a first function on at least one second computing device;
determine that the aggregated performance metrics are to meet a threshold; and
compile code associated with the first function in response to the aggregated performance metrics being determined to meet the threshold.

40. The at least one non-transitory computer readable storage medium of claim 39, wherein the instructions, when executed, cause the first computing device to:
identify at least one first performance metric, wherein the at least one first performance metric is a first number of invocations of the first function on one computing device of the at least one second computing device;
identify at least one second performance metric, wherein the at least one second performance metric is a second number of invocations of the first function on another computing device of the at least one second computing device; and
aggregate the at least one first performance metric and the at least one second performance metric to generate the aggregated performance metrics that are to correspond to the first and second number of invocations.

41. The at least one non-transitory computer readable storage medium of claim 39, wherein the instructions, when executed, cause the first computing device to:
determine the threshold based on a cost to compile the first function;
determine a number of invocations associated with execution of the first function based on the aggregated performance metrics; and
in response to the number of invocations being determined to meet the threshold, compile the code associated with the first function to generate the compiled code.

42. The at least one non-transitory computer readable storage medium of claim 39, wherein the instructions, when executed, cause the first computing device to:
propagate the compiled code to the at least one second computing device.

43. The at least one non-transitory computer readable storage medium of claim 39, wherein the at least one second computing device is to execute the compiled code.

44. The at least one non-transitory computer readable storage medium of claim 39, wherein the instructions, when executed, cause the first computing device to:
identify a hardware profile of the at least one second computing device; and
compile the code associated with the first function based on the hardware profile to generate the compiled code.

45. A method associated with a first computing device, comprising:
aggregate performance metrics associated with an execution of a first function on at least one second computing device;
determining that the aggregated performance metrics meet a threshold; and
compiling code associated with the first function in response to the aggregated performance metrics being determined to meet the threshold.

46. The method of claim 45, further comprising:
identifying at least one first performance metric, wherein the at least one first performance metric is a first number of invocations of the first function on one computing device of the at least one second computing device;
identifying at least one second performance metric, wherein the at least one second performance metric is a second number of invocations of the first function on another computing device of the at least one second computing device; and
aggregating the at least one first performance metric and the at least one second performance metric to generate the aggregated performance metrics that are to correspond to the first and second number of invocations.

47. The method of claim 45, further comprising:
determining the threshold based on a cost to compile the first function;
determining a number of invocations associated with execution of the first function based on the aggregated performance metrics; and
in response to the number of invocations being determined to meet the threshold, compiling the code associated with the first function to generate the compiled code.

48. The method of claim 45, further comprising:
propagating the compiled code to the at least one second computing device.

49. The method of claim 45, wherein the at least one second computing device is to execute the compiled code.

50. The method of claim 45, further comprising:
identifying a hardware profile of the at least one second computing device; and
compiling the code associated with the first function based on the hardware profile to generate the compiled code.
